(19) United States
(12) Patent Application Publication
(10) Pub. No.: US 2014/0369826 A1
(43) Pub. Date: Dec. 18, 2014

(54) TORNADO WIND ENERGY CONVERSION SYSTEM WIND TURBINE

(71) Applicants: Steven Rohring, Niagara Falls, NY (US); Raymond F. Ellis, Shorewood, IL (US)

(72) Inventors: Steven Rohring, Niagara Falls, NY (US); Raymond F. Ellis, Shorewood, IL (US)

(21) Appl. No.: 14/048,036

(22) Filed: Oct. 8, 2013

Related U.S. Application Data
(60) Provisional application No. 61/710,340, filed on Oct. 5, 2012.

(51) Int. Cl. F03D 3/04

(52) U.S. Cl. CPC F03D 3/0427
USPC 415/207

(57) ABSTRACT

A Vertical-Axis Double-Ducted Vortex-Diffuser-Augmented Wind Turbine comprises an apparatus further comprising a large, hollow, cylindrical tower with external fixed, wind concentrating cowlings and internal hinged, wind inlet vanes. The cowlings are large curved sections that extend outward from the cylindrical tower and perform two functions: 1) capture the wind, entraining it into a tower's core on an upwind side of the tower; and 2) shade a downwind side of the cylindrical tower from the wind, creating a negative pressure on downwind inlet vanes. The inlet vanes extend into the tower's cylindrical core, automatically opening to allow the wind to enter on the upwind side of the tower and automatically close on the downwind side of the cylindrical tower. By working together the external cowlings and internal inlet vanes enable the cylindrical tower to capture and entrain the wind stream into a contained tornado-like vortex.

### FIELD OF THE DISCLOSURE

The present disclosure relates generally to wind turbine apparatuses and, more particularly, to a Four Dimensional Wind Energy System called a Vertical-Axis Double-Ducted Vortex-Diffuser-Augmented Wind Turbine (hereinafter referred to as a Vortex Wind Turbine).

### BACKGROUND

Wind as a source of energy is a concept that has been promoted from ancient time. Various known designs of wind turbine structures have been used to make the most of wind as a source of energy. These wind turbines include horizontal axis wind turbines (HAWTs) typified by the common, open propeller blade type as well as various versions of the diffuser-augmented (ducted) type (DAWTs); and vertical axis wind turbines (VAWTs), the so-called Darrieus blade type turbine, and the so-called Savonius blade type turbine.

HAWTs have been used extensively to drive electrical generators, however they suffer from several disadvantages, including the need for an even horizontal air inflow, danger to birds and air traffic, obscuring the landscape with banks of rotating turbine blades, and in the case of large diameter HAWTs, noise from rotor blade tips traveling at supersonic speeds.

VAWT have been provided in the prior art with a central rotor surrounded by stationary devices that serve to redirect and compress airflow toward the rotor blades.

Compared to a VAWT where its exposure remains constant regardless of the wind direction, the horizontal axis wind turbine must turn to face the wind, which is a disadvantage as there are additional moving parts involved in the construction.

Several Savonius or “S”-rotor blade designs are also well known in the art and each of those various Savonius-type blade designs have inherent limitations, including the limitation of noise during operation, excessive vibration during operation, a tendency to “run away” during elevated wind speed operations and often excessive drag created during rotation of the leeward or non-wind-gathering portion of the blade's movement.

Further, various Darrieus-type turbine blade designs are also well known in the art and also have several inherent deficiencies, including that only the middle one-third of their blade length efficiently creates power; that the farther the distance from a curved blade to its axis of rotation, the greater the likelihood, especially in large scale power generation units, of a Darrieus-type unit going into harmonic vibration and self-destructing; that all such Darrieus-blade type units are not self-starting, but need assistance in starting; and that in many wind conditions they can, on a periodic basis, use up more energy than they actually produce. Without proper controls and/or mechanical braking systems, Darrieus type units have been known to “run away” during elevated wind speed conditions.

Further yet, there have been attempts at combining a bucket-shaped Savonius-type drag blade system with a Darrieus-type curved lift blade system, however significant difficulties arose relative to the operational, i.e., rotational, stability of the unit at high wind speeds. In addition, the combination of a Savonius bucket rotor to start the Darrieus rotor resulted in a reduction in the total turbine power and high braking torque at higher rotational rates. There were also the above-noted inherent problems present in all separate Darrieus and Savonius-type blade systems.

Further yet, other wind turbines on one extreme use 3 bladed turbines in open air and these wind turbines dominate today because of their simplicity and ease to produce. The main problem with these designs is that they take up a lot of space for the amount of energy produced. This makes them impractical for rooftop applications and difficult to permit in many locations.

On the other extreme are Diffuser Augmented Wind Turbines (DAWTs), which surround the rotor blades with a shroud or duct. DAWTs claim the most efficient power conversion in the same amount of wind, swept area (diameter of the blades) as open blade turbines. The main problem is the cost to produce the diffuser, as they have been complex to manufacture historically.

DAWTs also have a number of problems including, excessive noise and vibration, often self-destruct in high wind conditions, some require separate start-up, braking or stopping mechanisms, and many are not considered safe, readily insurable or building-code permitted, at least not for use in congested urban settings.

Thus, a heretofore unaddressed need exists in the industry to address the aforementioned deficiencies and inadequacies.

### SUMMARY

The present disclosure provides an apparatus comprising a wind turbine, which provides the lowest cost wind turbine power rating for a given amount of space by extracting the most amount of energy output from that space at the lowest energy cost. A previously proposed idea to capture energy from the wind indirectly was to use a hollow tower with vertical louvers that could be selectively opened and closed to entrain the wind stream into a contained tornado-like vortex. However, the idea was abandoned because the tower could not adequately create, contain and concentrate a strong enough vortex.

Briefly described, in one embodiment, an apparatus comprising a large, hollow, cylindrical tower with external fixed, wind-concentrating cowlings and internal hinged, wind inlet vanes sits atop the tower. The cowlings are large curved sections that extend outward from the cylindrical tower and perform two functions: 1) capture the wind, entraining it into a tower's core on an upwind side of the tower; and 2) shade the downwind side of the cylindrical tower from the wind, creating a negative pressure on downwind inlet vanes. The inlet vanes extend into the tower's cylindrical core, automatically opening to allow the wind to enter on the upwind side of the tower and automatically closing on the downwind side of the cylindrical tower. By working together the external cowlings and internal inlet vanes enable the cylindrical tower to capture and entrain the wind stream into a contained tornado-like vortex.

The vortex wind turbine will not only be able to compete against small wind companies with a lower cost, more efficient system, it will also be able to better compete against large wind farms through a modular approach (i.e. dozens of smaller turbines are more cost effective to produce and install at the same power rating as larger turbines that are difficult to manufacture, transport and install).

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

In FIGS. 1-7, a unidirectional wind turbine apparatus 100 is shown.

FIG. is a side view of the unidirectional wind turbine apparatus.

FIG. 2 is an exploded view of the unidirectional apparatus of FIG. 1.

FIG. 3 is a front elevational cross-sectional view of the apparatus of FIG. 1 with the front half of the apparatus removed. FIG. 4 is an exploded view of the apparatus of FIG. 1.

FIG. 5 is a side view of the apparatus of FIG. 1.

FIG. 6 is a cross-sectional top view of the apparatus of FIG. 1.

FIG. 7 is an cross-sectional exploded back view of the apparatus of FIG. 1.

FIG. 8 is perspective view of the apparatus of FIG. 1 with a vane and a rotational base element.

FIG. 9 illustrates a side view of wind pressure of the apparatus of FIG. 1.

FIG. 10a illustrates a side view of wind speed of the apparatus of FIG. 11.

FIG. 10b illustrates a side view of wind direction of the apparatus of FIG. 11.

FIG. 11 illustrates an omnidirectional wind turbine apparatus.

FIG. 12 is an exploded view of the apparatus of FIG. 11.

FIG. 13a is top view of the apparatus of FIG. 11.

FIG. 13b 13b is a cross sectional top view of the apparatus of FIG. 11 of the wind, allowing for function in response to wind coming from any direction.

FIG. 13c is a cross sectional top view of the apparatus of FIG. 11 showing wind direction.

FIG. 14 is side view of the apparatus of FIG. 11.

FIG. 15-18 depict data, which compares a 7 kw TWECS unit rated at 9 m/s against a 5 kw HAWT unit with the same wind swept area rated at 12 m/s.

### DETAILED DESCRIPTION OF THE EMBODIMENTS

Reference is now made in detail to the description of the embodiments as illustrated in the drawings. While several embodiments are described in the connection with these drawings, there is no intent to limit the disclosure to the embodiment or embodiments disclosed herein. On the contrary, the intent is to cover all alternatives, modifications, and equivalents.

It should be clearly understood that like reference numerals are intended to identify the same structural elements, portions, or surfaces consistently through out the several drawing figures, as may be further described or explained by the entire written specification of which this detailed description is an integral part. The drawings are intended to be read together with the specification and are to be construed as a portion of the entire “written description” of this invention as required by 35 U.S.C. §112.

Before a discussion of turbine performance, efficiencies and Conventional Wind Energy Conversion Systems it is important to understand some simple formulas that explain wind energy. Wind is made up of moving air molecules which have mass. A moving object with mass carries kinetic energy in an amount, which is given by the equation: Kinetic Energy=0.5×Mass×Velocity². Where mass is measured in kilograms (kg), velocity in meters per second (m/s), and the energy is given in joules. Air has a known density (around 1.23 kg/m3 at sea level), so the mass of air hitting a wind turbine (which sweeps a known area) each second is given by the following equation: Mass/sec (kg/s)=Velocity (m/s)×Area (m2)×Density (kg/m3). The power (i.e. energy per second) in the wind hitting a wind turbine with a certain swept area is given by simply inserting the mass per second calculation into the standard kinetic energy equation given above resulting in the following vital equation: Power=0.5×Swept Area×Air Density×Velocity3. Where Power is given in Watts (i.e. joules/second), the Swept area in square meters, the Air density in kilograms per cubic meter, and the Velocity in meters per second.

The simplest definitions of kW and kWh are as follows: kW=one thousand watts (and a watt is one joule of energy per second); and kWh=using a thousand watts for an hour (3,600,000 joules). Kilowatts are a unit of power, while kWh is a unit of energy. kW defines how much energy a device uses or generates in a given amount of time. Meanwhile kWh defines how much energy that device actually used or generates. A 100-watt light bulb that is on for 10 hours needs 1 kWh (1,000 watt-hours). This is the same as ten 100-watt bulbs burning for one hour.

Here is a Real World Wind Power Calculation for Traditional Turbines for the purpose of promoting and understanding the present claimed invention. In a 10 mph wind there are 100 Watts of power available with a 5 foot diameter wind turbine. Betz's law for wind turbine efficiency lowers this to 59.26 Watts, and with a “good” turbine losses are down to at most 35 watts of output. A good wind turbine today is defined as a power coefficient of 0.35 (CP). This is described as a 35% efficient turbine (generally they are lower than this). It is only enough power to power a couple of efficient light bulbs. By comparison, a 10 foot diameter turbine has 401 Watts available, 238 W with a fully efficient turbine (Betz's law), and 140 W output in the best open blade turbine design. A “good” 20-foot diameter three bladed turbine could possibly give 740 W at 10 mph.

When wind speed is doubled to 20 mph, the exponential increase in power available becomes apparent 280 possible Watts from a “good” 5-footer, 1,100 W from a 10-foot diameter, and 5,900 W from a 20 foot diameter.

The Betz law of physics states that an open blade wind turbine cannot possibly achieve 60% efficiency. However, DAWT companies are claiming wind swept area efficiencies of 70% to 80% (Power Coefficient). While others are claiming they beat Betz's law the inventors are not making such claims.

The efficiency of a DAWT does not correlate to Betz calculations because there is extra surface involved with a 3D effect to capture more air with the diffuser. Betz only works in 2D for the wind coming against a specifically known surface area such as the diameter of a 3-blade turbine (wind swept area).

Even though some DAWTs claim a power coefficient of over 100% for the blade area the inventors are not claiming any single value specific efficiency of the wind turbine. Efficiency and CP are two different calculations for DAWTs whereas efficiency and CP are interchangeable for open blade turbines. Open blade wind turbines are almost always in the 15% to 35% (0.15 to 0.35 CP) range. The true efficiency for DAWT designs is not well known but the adjusted CP has been shown to be at 900%.

| | | Available | | Sea Level | | | | | |
|---|---|---|---|---|---|---|---|---|---|
| Effective | Achievable | 2D max | | air density | Swept area | Wind | Wind | Blade | |
| Power (CP) | 3D Power kW | Power kW | Constant | kg/m3 | m2 | speed m/s | Velocity3 | Dia. (m) | Radius |
| 30.00% | 0.36 | 1.19 | 0.5 | 1.225 | 7.0686 | 6.5 | 274.625 | 3 | 1.5 |
| 70.00% | 0.83 | 1.19 | 0.5 | 1.225 | 7.0686 | 6.5 | 274.625 | 3 | 1.5 |
| 100.00% | 1.19 | 1.19 | 0.5 | 1.225 | 7.0686 | 6.5 | 274.625 | 3 | 1.5 |
| 300.00% | 3.57 | 1.19 | 0.5 | 1.225 | 7.0686 | 6.5 | 274.625 | 3 | 1.5 |
| 600.00% | 7.13 | 1.19 | 0.5 | 1.225 | 7.0686 | 6.5 | 274.625 | 3 | 1.5 |
| 900.00% | 10.70 | 1.19 | 0.5 | 1.225 | 7.0686 | 6.5 | 274.625 | 3 | 1.5 |

### Small Wind Turbine Comparison—Competitors

Comparison for non-DAWT style-conventional HAWT (Horizontal Axis)

| | | | | Rated |
|---|---|---|---|---|
| | Diameter | Swept Area | Rated Power | windspeed |
| Unit Name | (M) | (M2) | (kW) | (m/s) |
| Proven 2.5 kW | 3.5 | 9.6 | 2.5 | 12 |
| Proven 6 kW | 5.5 | 23.8 | 6 | 12 |
| Proven 15 kW | 9 | 63.6 | 15 | 12 |
| Gaia 11 kW | 13 | 132.7 | 11 | 9.5 |
| Iskra AT5-1 | 5.4 | 22.9 | 5 | 12 |
| Westwind 10 kW | 6.2 | 30.2 | 10 | 14 |
| Westwind 20 kW | 10.4 | 84.9 | 20 | 14 |
| Entegrity EW50 | 15 | 176.7 | 50 | 11.3 |
| Eoltec Scirroco | 5.6 | 24.6 | 6 | 11.5 |
| Eoltec 20 kW | 11 | 95.0 | 25 | 10.5 |
| Fortis Alize | 7 | 38.5 | 10 | 13 |
| Fortis Montana | 5 | 19.6 | 5.8 | 18 |

| | | | | sea level | | | | |
|---|---|---|---|---|---|---|---|---|
| Power Coefficient | Actual Rated | Maximum | | air density | Swept area | Wind speed | Wind | Blade |
| CP Value | Power kW | Power kW | Constant | kg/m3 | m2 | m/s | Velocity3 | Diameter (m) |
| 23.86% | 6 | 25.15 | 0.5 | 1.225 | 23.75635 | 12 | 1728 | 5.5 |
| 19.31% | 10 | 51.79 | 0.5 | 1.225 | 38.4846 | 13 | 2197 | 7 |
| 15.78% | 11 | 69.70 | 0.5 | 1.225 | 132.7326 | 9.5 | 857.375 | 13 |
| 19.71% | 10 | 50.74 | 0.5 | 1.225 | 30.190776 | 14 | 2744 | 6.2 |
| 32.02% | 50 | 156.18 | 0.5 | 1.225 | 176.715 | 11.3 | 1442.897 | 15 |

### Comparison for VAWT (Vertical Axis) Styles

| | | | Rated |
|---|---|---|---|
| | Swept Area | Rated Power | windspeed |
| Unit Name | (M2) | (kW) | (m/s) |
| Quietrevolution QR5 | 13.6 | 7.2 | 13.5 |
| Big Star Vertical WindRotor | 36.6 | 20 | 14 |
| Maxi Vertical WindRotor 6 Kw | 11.8 | 6 | 14 |
| Simply Vertical 3 Kw | 6.6 | 3 | 14 |

| Power | | | | | | | |
|---|---|---|---|---|---|---|---|
| Coefficient | Actual Rated | Maximum | | air density | Swept area | Wind speed | Wind |
| CP Value | Power kW | Power kW | Constant | kg/m3 | m2 | m/s | Velocity3 |
| 27.05% | 3 | 11.09 | 0.5 | 1.225 | 6.6 | 14 | 2744 |
| 35.13% | 7.2 | 20.49 | 0.5 | 1.225 | 13.6 | 13.5 | 2460.375 |
| 32.51% | 20 | 61.51 | 0.5 | 1.225 | 36.6 | 14 | 2744 |

This is a Comparison of Power Coefficients for the purpose of promoting and understanding the present claimed invention. The following table shows how important the CP value is in order to determine how much power is actually produced. All of the sizes and wind speeds are apples to apples. The only thing different in each row of the table is the CP value. The first CP value of 30% would be for a 3 bladed turbine while all others would be DAWT values. Note that, as the CP value rises incrementally, the power rating rises exponentially and become orders of magnitude greater.

A Conventional Wind Energy Conversion Systems (WECS) extract kinetic energy from the wind by simultaneously accelerating turbine blades and decelerating the wind. According to Betz' Law, conventional WECS are limited to the maximum theoretical Coefficient of Power (Cp) of 0.593. Kinetic energy increases by the square of the wind speed. So, theoretically, doubling the wind speed quadruples the amount of energy captured. Convention wind turbines produce about 40 watts per square foot of rotorsweep in a 30-MPH wind.

Power, however, is not a simple function of wind speed but is calculated as the product of kinetic energy and flow rate through the turbine. Power (also called Flow Pressure) increases by the cube of the wind speed. Power, therefore, can be increased by designing turbine blades that capture more kinetic energy or by designing a structure to increase the flow rate of wind through the turbine.

The Diffuser-Augmented Wind Turbine (hereinafter known as: “DAWT”) uses a stationary, tunnel-like cowling (convergent-divergent diffuser) surrounding the turbine just clear of the blades tips, which is narrower in front and expands in diameter downwind. This configuration creates a drop in air pressure behind (downwind of) the rotor blades allowing increased airflow through the turbine causing a 5 to 6-fold increase in power, with a calculated Cp of ˜2.0. DAWTs generate about 240 watts per square foot of rotor-sweep in a 30-MPH wind.

At a wind speed of 15-MPH, the flow pressure energy is 3,600 times greater than the wind pressure energy. Therefore, increasing flow pressure by utilizing a structure to reduce air pressure behind the turbine seems a more profitable venture than trying to increase wind pressure energy by further optimizing the aerodynamic efficiency of a HAWT's turbine blades.

Thus, in 1975, a proposed way to capture energy from the wind indirectly was to use a large, hollow, cylindrical tower with vertical louvers that could be selectively opened and closed to entrain the wind stream into a contained tornado vortex. Thus, it was theorized that when the tower's upwind louvers were open and the downwind louvers were closed, the wind stream was captured, contained and concentrated into a tornado-like vortex. Air at the top of the vortex was exhausted out the top of the tower; the wind stream entered the upwind louvers continuing to maintain the vortex. The continuous upward, spiral movement of air within the vortex created an area of very low pressure at the base of the vortex. A vertical-axis turbine was located at the bottom of the tower (just below the base of the vortex) to take advantage of this low-pressure exhaust reservoir. However, the idea was abandoned for two reasons: 1) a cost-effective mechanism to open the windward vertical louvers and simultaneously close the leeward louvers in order to create a vortex could not be produced, and 2) the fixed louvered models created negative air pressure on the leeward louver's trailing edge that exhausted the wind stream out of the tower, destroying the vortex before it had a change to get started.

After numerous years of model testing it was concluded in a review article that, “prospects for achieving either a system power coefficient above 0.20 or a cost of energy less than $0.50/kWh (1979 dollars) appear to be poor.” Jacobs, E. W. (1983), Research Results for the Tornado Wind Energy System: Analysis and Conclusions. Proceedings of the ASME Solar Energy Division Fifth Annual Conference, April 18-21, pp. 606-617.

Current wind turbine install costs are high, often requiring subsidies. There is also the lack of mass producible supply of wind turbines and permitting issues for large turbines today. The tornado wind energy conversion system design has many advantages and will become apparent from the following as it solves all of the above issues as the tornado wind energy conversion system design allows for the making of hundreds of wind turbines per week in one highly effective facility while lowering costs to a point that subsidies are no longer required to compete against commercial power.

There are several important aspects that are integrated together into our vortex wind turbine. First, the design of the DAWT has been demonstrated to be the most efficient wind turbine design for a given wind swept surface area. However, their high cost of fabrication has prohibited them from being commercially viable in the past. The electrical innovations of a new software algorithms and generator hardware for advanced electrical conversion are implemented to extract more power at lower costs compared to standard electrical technology used in wind turbines. The inflexibility of current wind turbines do not have the ability to maximize power output under different wind conditions such as going from high speed to low speed wind. The vortex wind turbine is capable of going from high speed to low speed wind by an integration approach which extracts maximum power in real time as wind conditions change and allow energy to be produced beyond the maximum rating through flywheel effect storage of energy. Another problem with current wind turbines both open blade and other diffuser designs are they take up large areas. The vortex wind turbine is significantly smaller for wind farmland usage while making rooftop and building elevation installations practical.

A vortex wind turbine is developed to produce the lowest cost wind energy rating. This is also accomplished through the integration of high strength composite materials, which provide greater strength to weight rations and allow low cost surface area to capture more wind energy. The vortex wind turbine is a highly efficient and compact design with a new Double-Ducted Vortex-Diffuser-Augmented Wind Turbine (DDVtxDAWT) design, which extracts more energy in a smaller space than all known conventional wind turbines. Also, the vortex wind turbine comprises a low cost, highly efficient direct drive electrical system, which eliminates expensive electronics inverters, while producing more power from a variable reluctance generator. No gearbox is utilized making it more reliable.

The price range per rated generator watt is now lowered to less than $1 when installing multiple units such as a wind farm. The cost depends on size, location and mounting method (i.e. rooftop or tower). A cost of $1.50 to $2 per rated generator watt is achievable for installation costs of turbines in one off situations.

Various size ranges of the vortex wind turbine will be supplied to compete against both small wind and large wind turbines. The following two small generator sizes (max rating) produce an annual energy output for the following Average Wind Speeds (AWS): 22 kW—produces an average energy output of 49,724 kWh at 7 m/s AWS; and 88 kW—produces an average energy output of 198,896 kWh at 7 m/s AWS.

What matters most when considering wind turbines is not the cost per generator rated watt but how much energy it actually produces over a period of time and the installed cost along with reliability factors to determine maintenance costs. Other wind turbine companies rate their generator for wind speeds not achievable in most regions such as 14 m/s. This speed is only achieved on rare occasions but the actual power produced on a regular basis is several times less than the rating.

Weibull curves for a specific location will show the median and mean numbers with a tail at the end of the spectrum for higher wind speeds. It is very important to design the system to work in mid to high wind speeds as there is very little value to extract power at low wind speeds of 4 m/s or less since wind power is a cubic function of its velocity as will become more apparent below in the following description of the claimed invention.

Averting now to the drawings, with reference to FIGS. 1-5, a preferred embodiment is a vortex diffuser apparatus comprising a large, hollow, cylindrical tower with fixed wind concentrating cowlings, and internal hinged, wind inlet vanes. The cowlings are large curved sections that extend outward from the cylindrical tower core and perform two functions: 1) they capture the wind, entraining it into the tower's core on the upwind side of the tower; and 2) shade the downwind cowlings from the wind, creating negative pressure on downwind inlet vanes. The inlet vanes extend into the tower's cylindrical core. The upwind inlet vanes are pushed open by the wind stream and allow the wind to enter the upwind side of the tower; while the downwind inlet vanes are kept closed by the positive pressure of the vortex from inside the core and the negative pressure from outside the core created by the aforementioned downwind cowlings. Thus, by working together—and utilizing only the power of the wind—the external cowlings and internal inlet vanes enable the tower to capture and entrain the wind stream into a contained vortex.

The Vortex Diffuser Tower allows the rotor blades to be more efficiently operated by a Venturi effect. This creates a low pressure exhaust reservoir behind the turbine which allows the rotor blades to spin more freely as the static pressure in front of the turbine is relieved; resulting in an increase in both the volume and velocity of air passing through the turbine. The open blade designs of conventional Wind Turbines have no way of relieving the static pressure that builds up in front of the turbine blades. This “traffic jam” of air molecules against the front surface of their rotor blades makes it more difficult for them to rotate.

The turbine is placed at the bottom of the cylindrical tower to take advantage of the low-pressure reservoir created by the vortex. A conical structure with upwardly and inwardly curved baffles is placed below the turbine to concentrate and direct the wind stream into the bottom of the turbine.

A turbine-rotor is designed to make use of a magnetic levitation or standard fixed mounted blades, which may use copper and/or iron and rare earth metals; a direct-drive variable generator, such as a flywheel generator and the like; inverters or converters; and electromechanical batteries or hydraulic transmissions for energy storage and power conversion.

The preferred embodiment of the vortex wind turbine will produce 10 times the energy of a conventional wind turbine without costing 10 times as much to build. Thus, the claimed invention reduces the cost of wind-generated electricity and enables more power to be produced.

The preferred embodiment uses exterior fixed Wind Concentrating Cowlings (WCCs) and interior, hinged Wind Inlet Vanes (WIVs). Each WIV is hinged to an inner edge of each WCC and can swing freely in an inward direction toward the cylindrical tower. Swinging in an outward is blocked by the adjacent WCC. When all WIVs are closed, swung fully outward touching their adjacent WCCs, they form a circular core of the cylindrical tower.

The wind stream may be caught by the fixed, upwind WCCs and is entrained toward the cylindrical tower's core. The wind pushes open the upwind WIVs, moves along the curved inner surface of the cylindrical tower's core, is entrained into the vortex, and is then exhausted out the top of the cylindrical tower. The vortex creates a pressure gradient across a vertical axis turbine located at the bottom of the cylindrical tower core.

Positive pressure of a circling wind inside the cylindrical tower's core and a negative pressure from the wind flowing around (rather than into) the downwind WCCs combine to keep the downwind WIVs closed. The external, fixed WCCs, therefore, act as both wind catchers, to open the upwind WIVs, and as wind blockers, to help close the downwind WIVs, and thus enable the cylindrical tower to create, contain and concentrate a tornado vortex. The preferred embodiment is thus a passive system, which uses only wind energy to open, and close the vanes, the cylindrical tower is an omni-directional and automatically (and instantaneously) adjusts to changes in wind direction. And since the WCCs can be made to any size within structural limits, the WCCS can gather wind from a far greater cross-sectional area than rotor blades of prior wind turbines. The preferred number of cowlings and vanes will vary with the diameter of the cylindrical tower. The larger the diameter of the cylindrical tower the larger the number of cowlings and vanes will be required.

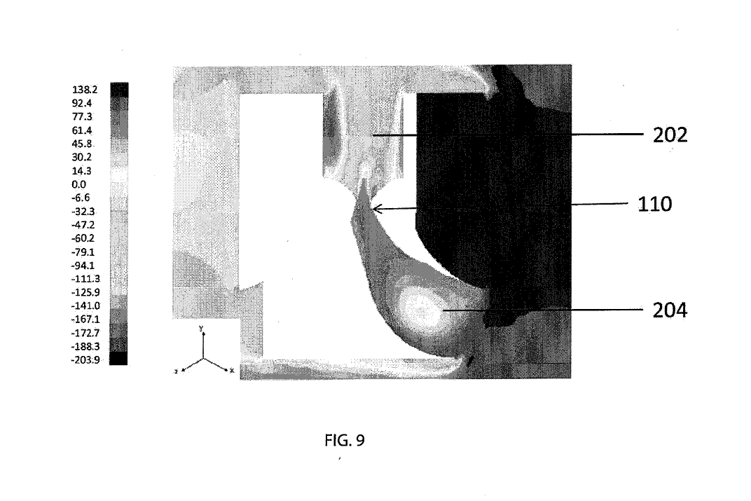

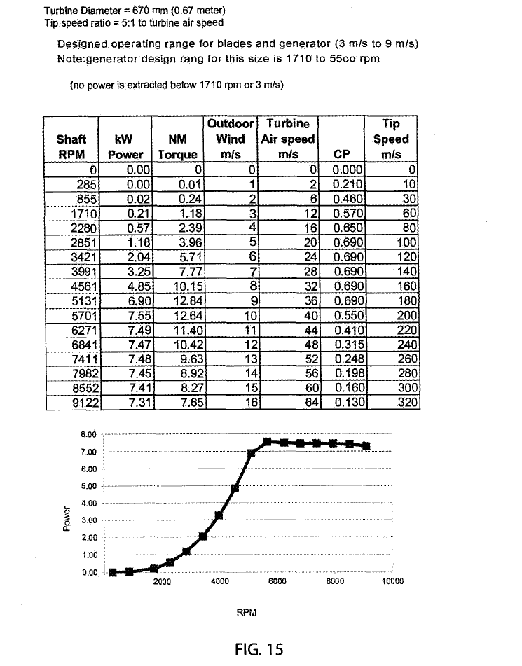

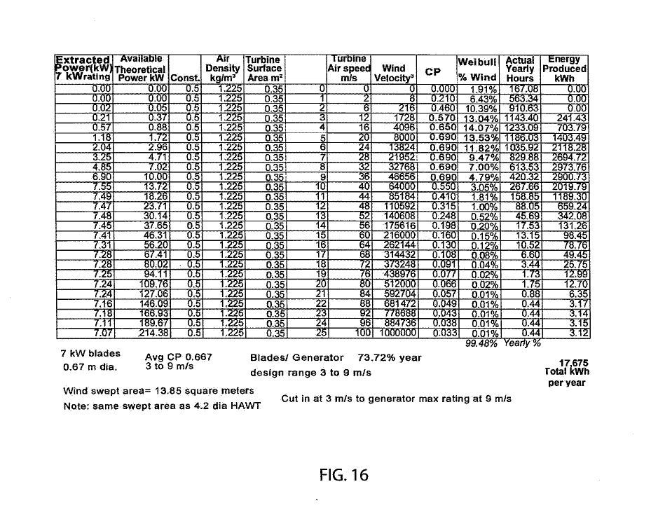

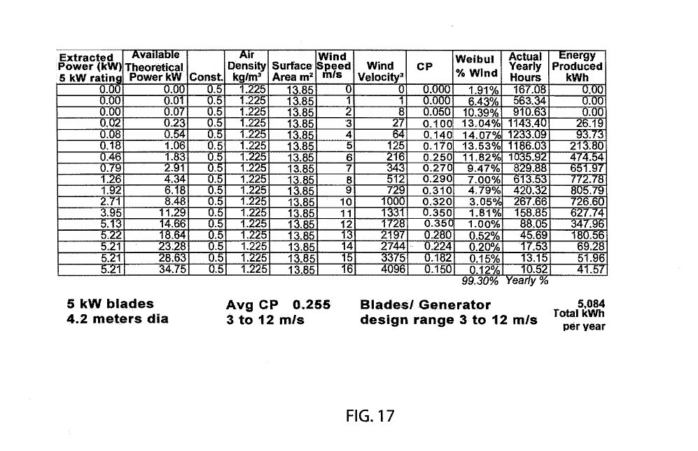

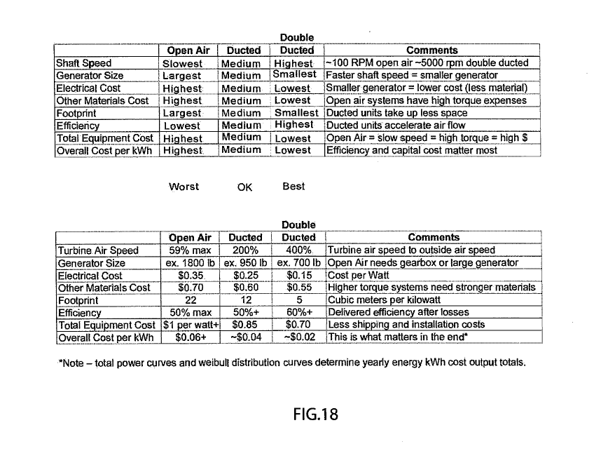

Averting now to the charts, with reference to FIGS. 15-18. The charts depict data, which compares a 7 kw TWECS unit rated at 9 m/s against a 5 kw HAWT unit with the same wind swept area rated at 12 m/s. The wind location for both charts was at the same location. The takeaway from the charts is the vortex wind turbine generates over 3× more energy in the same swept area and at a lower cost. FIG. 9 is a short side-by-side comparison of standard turbines vs ducted and double ducted with the vortex wind turbine being the only double ducted system. A short summary of the benefits of the vortex wind turbine from the charts follows. Also, the vortex wind turbine is a high speed system. This means the vortex wind turbine works well in the thousands of rpm's not hundreds or dozens like standard wind turbines. The vortex wind turbine does not need a gearbox and thus, allows smaller, higher rpm generators. The vortex wind turbine may also use a flywheel effect that stores kinetic energy during gusts and going over the power rating. This allows the vortex wind turbine to react easily against rapid wind changes whereas standard wind turbines do not respond quickly to gusting. The vortex wind turbine system also works more efficiently over a wider range of wind speeds because the intake duct acts as a lens to concentrate (increase) lower wind speeds, while the vortex acts as a flywheel to capture, store and buffer (accumulator) the energy in wind gusts. Therefore, the 3D double ducted DAWT combined with the 4D effect of the vortex wind turbine's 4^{th} dimensional time factor of storing energy in the vortex accumulator makes this design the most cost effective wind turbine at all wind speeds.

The double ducted system for the vortex wind turbine uses variable power extraction over a broad wind regime through the use of variable blades matched to a variable generator; a flywheel to store losses making the vortex wind turbine efficiency go way up because it stores the energy that might be normally lost; and the double ducted system is a high speed, low torque system, while all other wind turbines are low speed and high torque systems. Even standard DAWT's are typically high torque systems as they do not achieve thousands of rpm's to lower torque, and DAWT's require larger generators and/or gearboxes compared to vortex wind turbine.

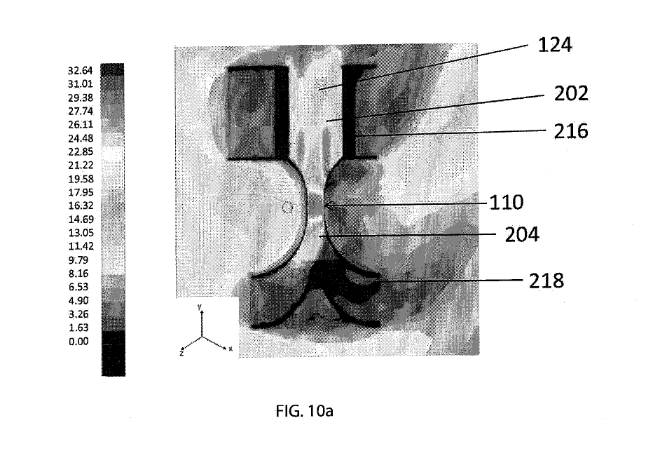

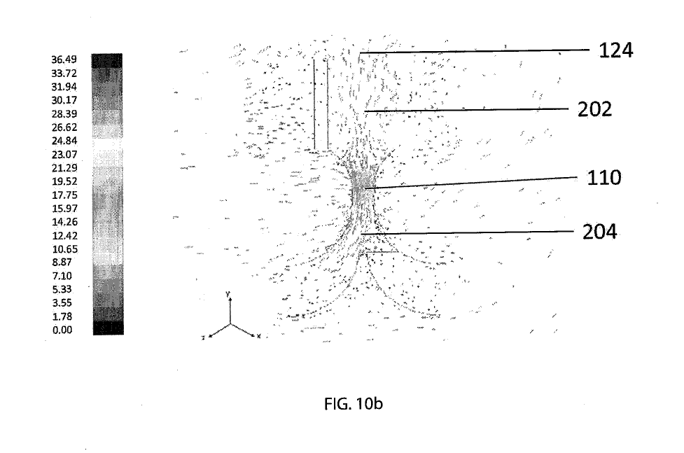

FIG. 10 is an image of the vortex wind turbine showing a pressure drop as the wind stream moves through the system. The image illustrates that the wind comes through the bottom inlet creating a positive pressure and the wind wants to go to the negative pressure (green section) vortex whereby it passes through the turbine section. The axis measurement is in Pascal's.

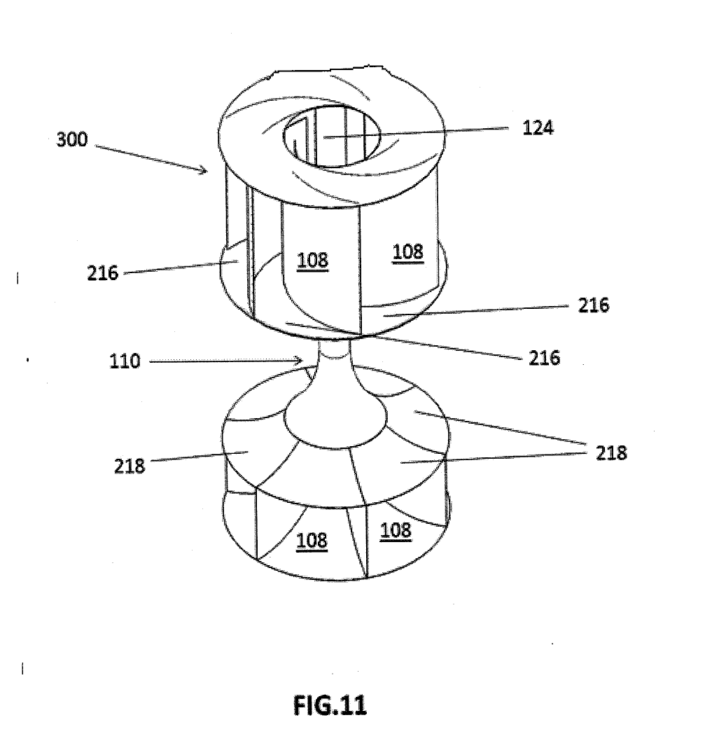

FIG. 11 is a CFD speed plot showing the wind speed increase in the turbine section compared to the outside air. The pressure as shown in FIG. 10 helps accelerate the air from an outside air velocity of 11 m/s to 33 m/s in the turbine section. The air passing through the turbine is traveling at velocity cubed of 33 m/s×33 m/s×33 m/s showing a 3× to 4× increase in air speed. The axis measurement is in meters per second (m/s).

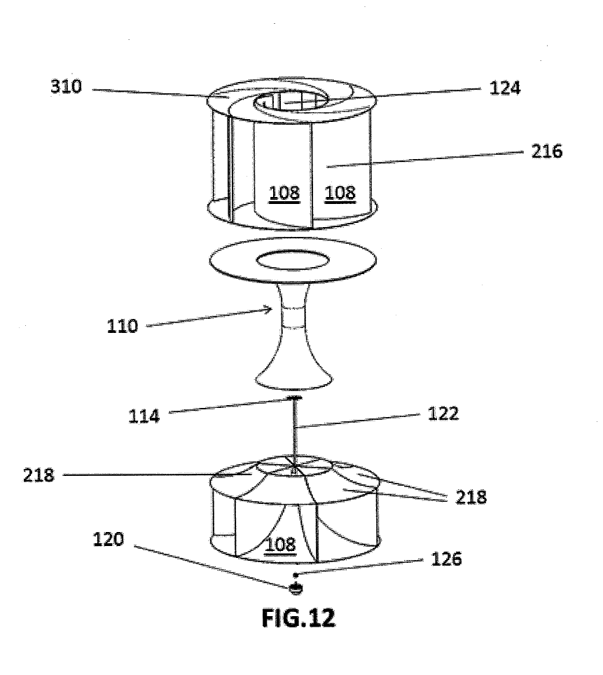

FIG. 12 is a CFD speed plot using arrows to show the wind speed increase in the turbine section compared to the outside air. The pressure as shown in FIG. 10 helps accelerate the air from an outside air velocity of 11 m/s to 33 m/s in the turbine section. The air passing through the turbine is traveling at velocity cubed of 33 m/s×33 m/s×33 m/s showing a 3× to 4× increase in air speed. The axis measurement is in meters per second (m/s).

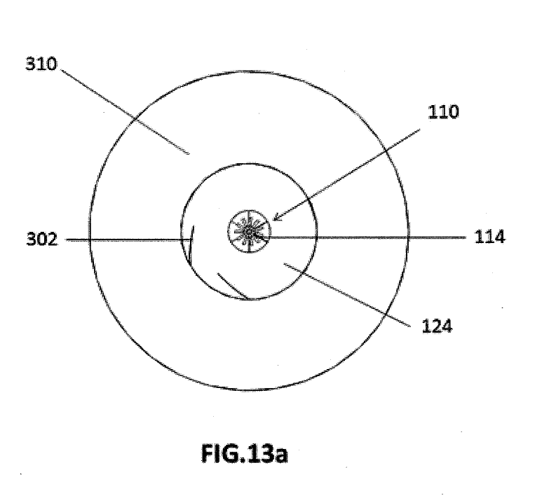

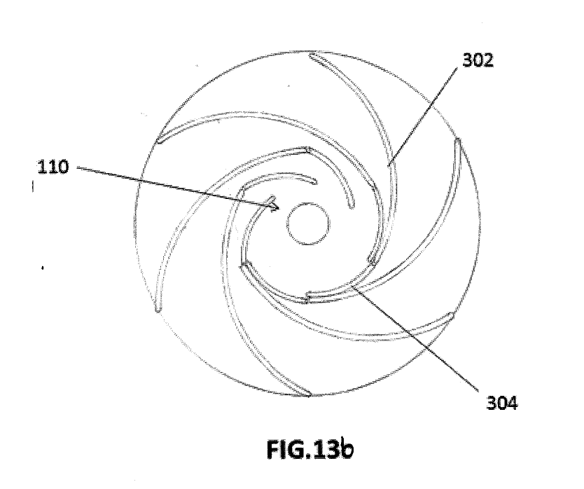

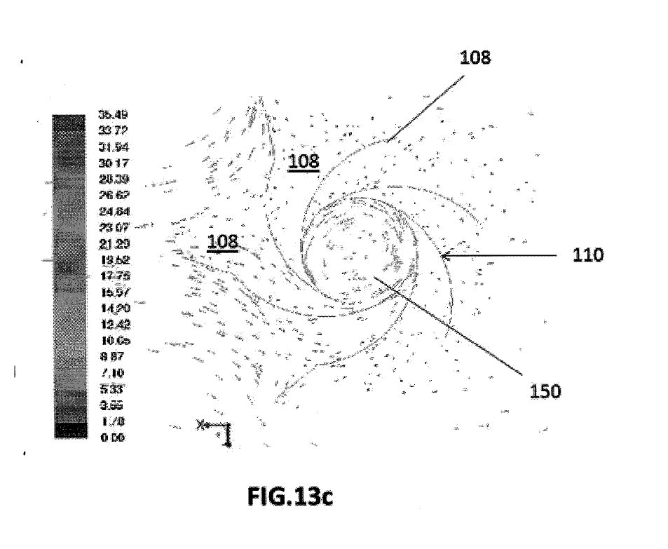

FIG. 13 is a top view CFD speed plot using arrows to show the wind speed increase in the turbine section compared to the outside air. The pressure as shown in FIG. 10 helps accelerate the air from an outside air velocity of 11 m/s to 33 m/s in the turbine section. The air passing through the turbine is traveling at velocity cubed of 33 m/s×33 m/s×33 m/s showing a 3× to 4× increase in air speed. The CFD speed plot also shows the forming of a vortex, thus creating a negative pressure. The axis measurement is in meters per second (m/s).

FIG. shows another embodiment of the Tornado Wind Energy Conversion System as a uni-directional system, where wind only works with the uni-directional system in one direction. The uni-directional system comprises a large, hollow, cylindrical tower with louvers with externally fixed, wind concentrating cowlings, a Diffuser, shaft, generator and internal hinged, wind inlet vanes.

FIG. shows another embodiment of the vortex wind turbine as a vane uni-directional system. The vane uni-directional system comprises of large, hollow, cylindrical tower with operable louvers with externally fixed, wind concentrating cowlings, a Diffuser, a shaft, a generator, bearing, internal hinged, wind inlet vanes and a vane located toward the top of the vane uni-directional system. The vane may be a wind vane, wherein the bearing allows the vane and the vane uni-directional system to rotate 360 degrees freely.

Another benefit of the vortex wind turbine is the interchangeability of the double duct size, the throat size and generator size to best match the efficiency of any location. The vortex wind turbine also includes a software component, which uses a parametric configuration to determine the best sized double duct, throat and generator to best match the efficiency of any location.

The overall benefits of the vortex wind turbine are the shipping costs will be reduced as the system can be shipped in a kit form on a standard truck. The local assembly on site is an easy install concept, saving time and shipping costs, as the vortex wind turbine does not need to ship fully assembled on a special truck. Gearboxes are eliminated and maintenance significantly reduced as no bearing or gearbox issues with a robust direct drive system. Erection costs are reduced as no heavy cranes or special roads are need. The vortex wind turbine significantly reduces the amount of concrete used because the overall weight of the vortex wind turbine allows for a smaller foundation. The vortex wind turbine is more efficient and cost effective than DAWT's, HAWTs or VAWTs. The vortex wind turbine also creates a low-pressure exhaust reservoir behind the turbine blades. The vortex wind turbine also uses a smaller sized turbine per unit of energy generated, thus it is more pleasing to the eyes and ears, being much smaller and quieter. Bird kills can be eliminated with minimal to no environmental impact. The vortex wind turbine captures all speed winds more efficiently via quicker starting and without cut out issues as the flywheel effect allows energy storage beyond the generator rating. The vortex wind turbine adjusts instantly to changes in wind direction without loss of efficiency. The vortex wind turbine also captures a 3D volume of wind stream much larger than a 2D rotor which allows a 4D time capture effect through the vortex (flywheel/accumulator effect).

Other benefits of the vortex wind turbine are as follows: it creates a pressure drop across the turbine larger than a DAWT's and therefore generates more power at same wind speeds; generates cost-effective power at lower wind speeds enabling wider placement of WTs; is omni-directional; the turbine is much smaller than the wind-gathering structure, enabling smaller turbine per unit of energy produced; uses a vertical-axis turbine (reduces gravitational stresses); and employs a stationary wind-gathering structure that can intercept a much larger cross-section of the wind stream than a HAWT, VAWT or DAWT. The vortex wind turbine also captures low, mid, and high speed winds more efficiently, adjusts instantly to changes in wind direction without loss of efficiency and captures a 3D volume of the wind stream much larger than a 2D rotor sweep of standard wind turbines.

Although exemplary embodiments have been shown and described, it will be clear to those of ordinary skill in the art that a number of changes, modifications, or alterations to the disclosure as described may be made such as the configuration of the tornado wind energy conversion system may interchange the double duct size, the throat size and generator size to best match the efficiency of any location. All such changes, modifications, and alterations should therefore be seen as within the scope of the disclosure.

In FIGS. 1-7, a unidirectional wind turbine apparatus 100 is shown.

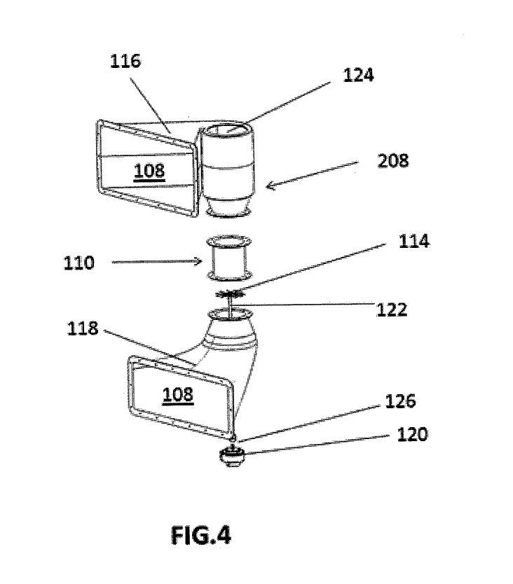

FIG. 1 illustrates the unidirectional wind turbine apparatus 100 having a wind inlet 108 at both ends. The wind inlet 108 extends to the turbine section 110. The wind inlets 108 permit wind to enter unidirectional wind turbine apparatus 100 at a diffuser scoop 116 and a turbine scoop 118. A turbine section 110 contains the rotor blades 104 that drives generator 120 via a shaft 122, as best seen in FIGS. 4 and 5, where said shaft is parallel to and coaxial to an axis drawn vertically from diffuser scoop 116 through turbine section 110, continuing through turbine scoop 118. The turbine section 110 is connected to diffuser scoop 116 and turbine scoop 118. The diffuser scoop 116 is associated with a region negative pressure 202 and turbine scoop 118 is associated with a region of positive pressure 204, as best seen in FIG. 9. The turbine section 110 houses rotor blades 114, as seen in FIG. 5, where the rotor blades 114 extend generally perpendicular to shaft 122. The shaft 122 is connected to a generator 120 by a coupling 126. The generator 120 is a standard machine element and therefore not shown in detail.

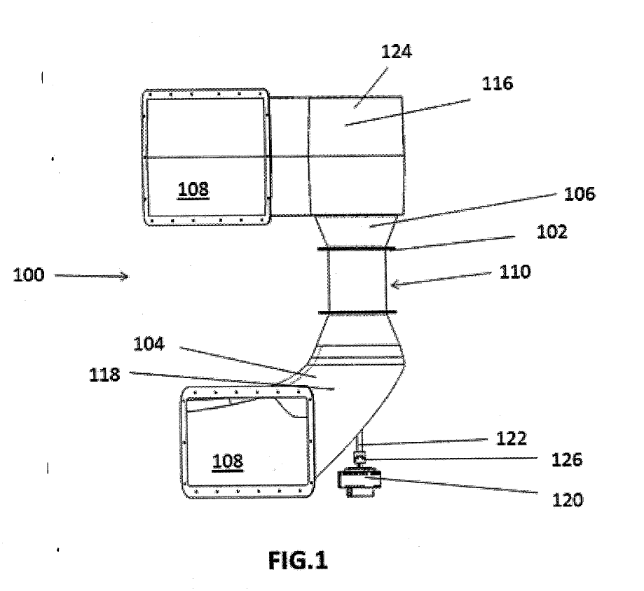

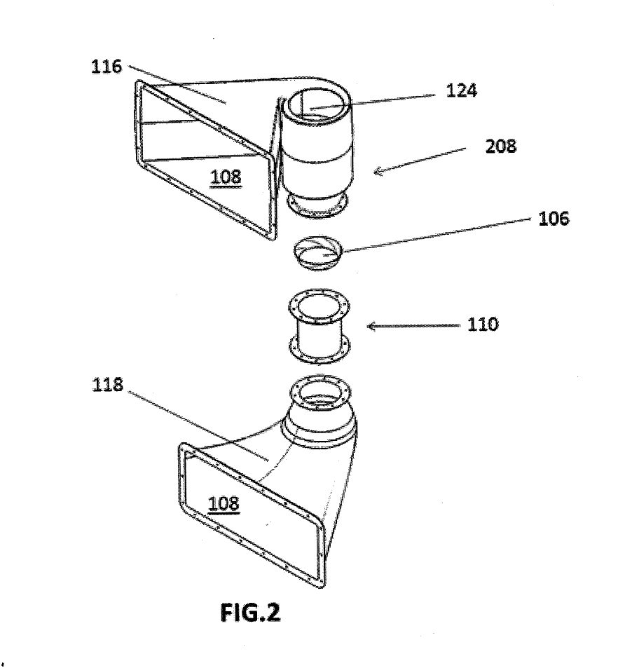

FIG. 2 is an exploded view of unidirectional wind turbine apparatus 100 illustrating a cowling 106 and an exhaust port 124. The exhaust port permits the exit of air passing from the region of positive pressure 204 to the region of negative pressure 202.

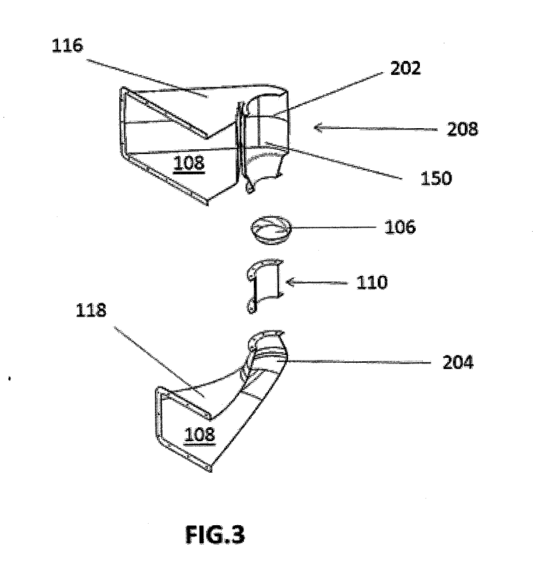

FIG. 3 is an exploded cross sectional view of FIG. 1, illustrating the location of vortex 150. As the wind enters wind inlet 108 at diffuser scoop 116, the air forms a vortex 150, further represented in FIG. 13c. A region of negative pressure 202, as seen in FIG. 9, is positioned before the outlet of the turbine section 110. The region of negative pressure 202 will draw air through the turbine section 110, causing rotation of turbine rotor blades 114. The air will then exit through an exhaust port 124 at the top of the unidirectional wind turbine apparatus 100.

FIG. 4 is an exploded perspective view of unidirectional wind turbine apparatus 100 illustrating the rotor blades 114 and the shaft 122 passing through the turbine scoop. The shaft 122 connects to generator 120 through coupling 126.

FIG. 5 shows a cross sectional side view of unidirectional wind turbine apparatus 100, further illustrating the connection between rotor blades 114, coupling 126 and generator 120.

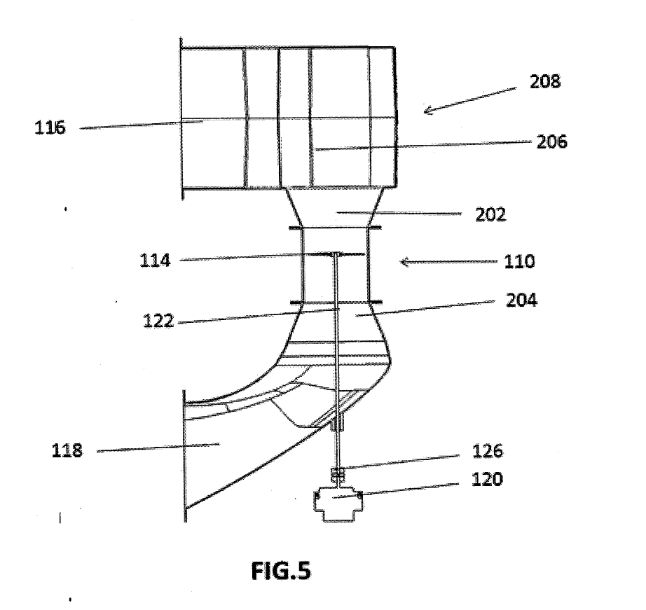

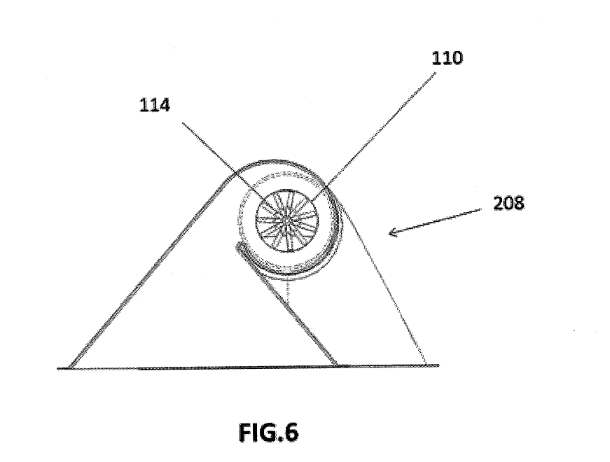

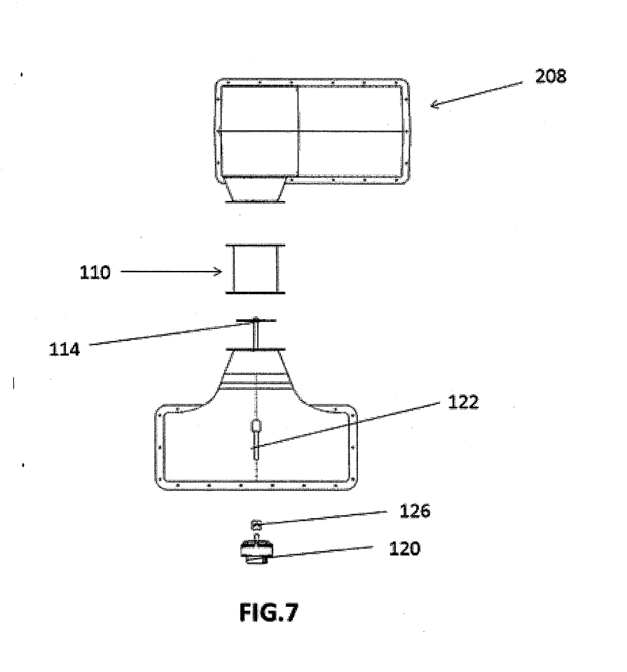

FIG. 6 is a top view of unidirectional wind turbine apparatus 100, illustrating rotor blades 114 and turbine section 110. FIG. 7 is an exploded cross sectional back view of unidirectional wind turbine apparatus 100, further illustrating the relationship between turbine section 110, rotor blades 114, coupling 126 and generator 120.

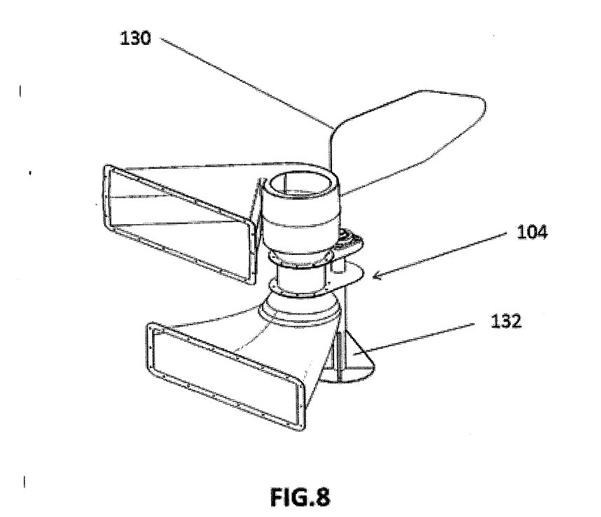

FIG. 8 illustrates an additional embodiment of the present invention, where a unidirectional vane 130, in combination with a rotating base member 132, permits the unidirectional wind turbine apparatus 100 to rotate based on the direction of the wind. Additionally, FIG. 8 illustrates a mounting region 104 that is generally applicable to all embodiments of the present invention.

FIG. 9 illustrates a wind pressure gradient, where 204 represents a region of positive pressure and 202 represents a region of negative pressure.

FIG. 10a illustrates wind speed. FIG. 10b illustrates wind direction.

FIG. 11 illustrates yet another embodiment of the present invention, where multiple wind inlets 108 form an omnidirectional wind turbine apparatus 300.

FIG. 12 illustrates an exploded view of omnidirectional wind turbine apparatus 300 of FIG. 11.

FIG. 12 shows rotor blades 114 in conjunction with shaft 122. In the fully assembled view of omnidirectional wind turbine apparatus 300 shown in FIG. 12, Shaft 122 is located inside of turbine section 110. A lid 310 illustrated in FIG. 12 covers an omnidirectional diffuser 308, best seen in FIG. 13b.

FIG. 13a illustrates a top view of omnidirectional wind turbine apparatus 300 with lid 310 illustrated. FIG. 13b illustrates a cross sectional top view of omnidirectional wind turbine apparatus 300, where a series of omnidirectional inlet vanes 302 are visible. The omnidirectional inlet vanes 302 open and close based on the direction of the wind, allowing for function in response to wind coming from any direction. FIG. 13c is cross sectional top view of omnidirectional wind turbine apparatus 300 illustrating wind inlets 108 and vortex 150. In FIG. 13c arrows represent wind direction.

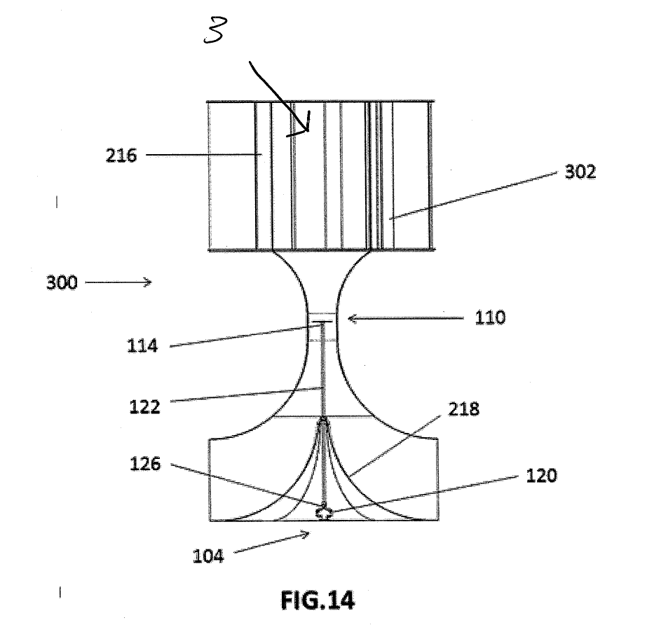

FIG. 14 is a cross sectional side view of omnidirectional wind turbine apparatus 300.

We claim:

1. A Vortex Diffuser Augmented Wind Turbine system which comprises:
at least one turbine scoop having an turbine scoop inlet to accept wind generated from outside said system and an turbine scoop outlet connected to a ducted turbine section including rotor blades to accept accelerated wind from said turbine scoop outlet;
a generally cylindrical ducted diffuser in communication with a turbine section outlet; wherein said diffuser has at least one diffuser scoop having a diffuser scoop inlet to accept wind generated from outside said system and an exhaust port to allow said wind to escape said diffuser scoop; whereas said diffuser accepts wind from said diffuser scoop inlet creating a generally cylindrical air vortex centrally containing negative air pressure;
ductwork connecting said turbine section inlet to said turbine scoop outlet;
a cowling connecting said turbine section outlet to said diffuser; whereas said negative pressure is proximate to the cowling to accept said accelerated wind from said cowling;
whereas said diffuser mixes air pressure streams into said vortex with wind coming from said cowling and from said diffuser scoop whereby accumulating accelerated wind from said turbine outlet with wind generated from outside said system passing through said diffuser scoop inlet; whereas said accumulation in said vortex is released back to outside wind regime through said exhaust port of said diffuser; and
a means for fastening said system to a base;
(dependent claim: wherein said base is the earth, a building or other structure);
The system according to claim 1 whereas outside wind is defined as natural wind or man-made wind from building ventilation or equipment exhaust, and whereas outside wind regime is defined as external wind to said system that is not accelerated inside said system, and whereas accelerated wind is defined as higher velocity wind mainly found inside said turbine section.

2. The system according to claim 1 whereas all ductwork of every system component is sealed from outside wind regime except to only allow outside wind into said turbine scoop inlet and said diffuser scoop inlet while only exhausting back to outside wind regime through said diffuser exhaust port.

3. Method according to claim 2 whereas said vortex air within diffuser section cannot enter back into said turbine section or said diffuser scoop as it must exhaust from said diffuser exhaust port due to the pressure differentials created by all said system ductwork that separates internal system air pressures from external wind regime air pressures, whereby accelerated wind from turbine section has greater air pressure than the outside wind regime air pressure after said diffuser exhaust port, and whereas said accelerated wind within said turbine section cannot enter back into said turbine scoop section as said accelerated wind must enter into said diffuser vortex due to the pressure differentials created by all said system ductwork, whereby the said turbine scoop air pressure is greater than the negative air pressure centrally located in said diffuser vortex after said turbine section outlet.

4. The system according to claim 1 whereas said turbine scoop inlet accepts wind whereby said turbine scoop inlet interior angle range is sloping between 45 degrees to 135 degrees from said turbine section inlet to said turbine scoop inlet in order to accelerate wind speed into the turbine section.

5. The system according to claim 1 whereas said cowling has a ducted angle outlet expanding between 45 degrees to 135 degrees from turbine section outlet to cowling outlet.

6. The system according to claim 1 whereas said diffuser scoop inlet accepts wind whereby said diffuser scoop inlet interior angle range is sloping between 45 degrees to 135 degrees from diffuser scoop outlet to said diffuser scoop inlet.

7. Method according to claim 3 whereby all said system ductwork seals said outside air wind regime from air generated within said system to maintain a continuous pressure flow system without adverse leakage.

8. Whereas the inverse angles of ducts in claims 5 and 7 are between 225 degrees to 315 degrees whereby said system ductwork of claim 3 only allows wind entry angles to enter said system between 45 degrees to 135 degrees while said inverse angles seal off remaining wind regime.

9. Whereas claim 9 works in conjunction with claim 4 to allow for a working pressure flow system without adverse leaks.

10. Whereas said diffuser according to claim 1 is situated inline (parallel) to turbine outlet.

11. Whereas said scoop according to claim 1 is a curved funnel whereby the scoop inlet is perpendicular to a shaft axis located within said turbine section.

12. Whereas ducts according to claims 1 and 3 may combine from singular ducts to form multiple ducts in order to achieve combined angles according to claims 5, 6 and 7.

13. Whereas said system according to claim 1 with means for connecting turbine rotor blades, shafts and power generation equipment including but not limited to electrical power generators and hydraulic power pumps, or any means useful to transfer energy from rotor blades to another location.

14. Whereas said turbine section according to claims 1, 4 and 8 realize an accelerated wind speed of at least three times faster wind speed than said outside wind speed regime entering inlets of said system.
